(19) United States
(12) Patent Application Publication
(10) Pub. No.: US 2014/0172133 A1
(43) Pub. Date: Jun. 19, 2014

(54) SYSTEM, METHOD, AND APPARATUS FOR POWERING, CONTROLLING, AND COMMUNICATING WITH LED LIGHTS USING MODIFIED POWER-OVER-ETHERNET

(71) Applicant: David M. Snyder, Cedar Rapids, IA (US)

(72) Inventor: David M. Snyder, Cedar Rapids, IA (US)

(21) Appl. No.: 14/108,938

(22) Filed: Dec. 17, 2013

Related U.S. Application Data
(60) Provisional application No. 61/797,877, filed on Dec. 17, 2012.
(60) Provisional application No. 61/797,873, filed on Dec. 17, 2012.
(60) Provisional application No. 61/797,872, filed on Dec. 17, 2012.
(60) Provisional application No. 61/797,870, filed on Dec. 17, 2012.
(60) Provisional application No. 61/797,869, filed on Dec. 17, 2012.
(60) Provisional application No. 61/797,866, filed on Dec. 17, 2012.
(60) Provisional application No. 61/797,865, filed on Dec. 17, 2012.

(51) Int. Cl. G05B 15/02

(52) U.S. Cl. CPC G05B 15/02
USPC 700/90

(57) ABSTRACT

A smart grid system, method, and apparatus for powering, controlling, and communicating with light emitting diode (LED) lights using Modified Power over Ethernet (M-PoE), which includes capabilities such as the added capability for PoE ports to be turned on-off in response to a signal, and to be have a PoE port's output voltage regulated in response to a signal. M-PoE equipment includes PSE and PD equipment configured such as, but not limited to, midspans, end-spans, etc. The smart grid is a digitally enabled local electrical power distribution grid that is enabled to gather, distribute, and act on information about the behavior of all attached devices, including schedules, time of day, season, occupancy, etc., in order to improve the efficiency, reliability, and economics of electricity services. In addition, the smart grid may also communicate with the larger smart grid, and also may be controlled by the larger smart grid.

### CROSS-REFERENCE TO RELATED APPLICATIONS

This application claims priority to U.S. Provisional Application, Ser. No. 61/797,877 filed Dec. 17, 2012 which is entitled System, Method, And Apparatus No. 1 For Powering, Controlling, And Communicating With LED Lights Using Combined Low Voltage Power/Data Cabling Excluding Ethernet Wiring.

This application claims priority to U.S. Provisional Application, Ser. No. 61/797,873 filed Dec. 17, 2012 which is entitled System, Method, And Apparatus No. 7 For Powering, Controlling, And Communicating With LED Lights Using Combined Low Voltage Power/Data Cabling Excluding Ethernet Wiring.

This application claims priority to U.S. Provisional Application, Ser. No. 61/797,872 filed Dec. 17, 2012 which is entitled System, Method, And Apparatus No. 8 For Powering, Controlling, And Communicating With LED Lights Using Combined Low Voltage Power/Data Cabling Excluding Ethernet Wiring.

This application claims priority to U.S. Provisional Application, Ser. No. 61/797,870 filed Dec. 17, 2012 which is entitled System, Method, And Apparatus No. 3 For Powering, Controlling, And Communicating With LED Lights Using Combined Low Voltage Power/Data Cabling Excluding Ethernet Wiring.

This application claims priority to U.S. Provisional Application, Ser. No. 61/797,869 filed Dec. 17, 2012 which is entitled System, Method, And Apparatus No. 4 For Powering, Controlling, And Communicating With LED Lights Using Combined Low Voltage Power/Data Cabling Excluding Ethernet Wiring.

This application claims priority to U.S. Provisional Application, Ser. No. 61/797,866 filed Dec. 17, 2012 which is entitled System, Method, And Apparatus No. 6 For Powering, Controlling, And Communicating With LED Lights Using Combined Low Voltage Power/Data Cabling Excluding Ethernet Wiring.

This application claims priority to U.S. Provisional Application, Ser. No. 61/797,865 filed Dec. 17, 2012 which is entitled System, Method, And Apparatus No. 5 For Powering, Controlling, And Communicating With LED Lights Using Combined Low Voltage Power/Data Cabling Excluding Ethernet Wiring.

The aforementioned provisional applications are herein incorporated in their entirety by reference.

### FIELD OF THE INVENTION

The present invention relates to a local smart grid system, method, and apparatus for powering, controlling, and communicating with light emitting diode (LED) lights using Modified Power over Ethernet (PoE). The present invention's local smart grid is a digitally enabled local (in-building, campus-wide) electrical power distribution grid that is enabled to gather, distribute, and act on information about the behavior of all attached devices, including schedules, time of day, season, occupancy, ambient light, etc., in order to improve the efficiency, reliability, and economics of electricity services being utilized in the local smart grid. In addition, the present invention's smart grid may also communicate with the larger smart grid, and may also interact and be controlled by the larger smart grid.

### BACKGROUND OF THE INVENTION

Traditional Power over Ethernet or PoE technology describes a system designed to pass electrical power safely, along with data, on standard Ethernet cabling. The IEEE standard for PoE requires category 5 cable or higher for high power levels, but can operate with category 3 cable for low power levels. Power is supplied in common mode over two or more of the differential pairs of wires found in the Ethernet cables and comes from a power supply within a PoE enabled networking device such as an Ethernet switch or can be injected into a cable run with a midspan power supply.

The original IEEE 802.3af-2003 PoE standard provides up to 15.4 W of DC power (minimum 44 V DC and 350 mA) to each device. Only 12.95 W is assured to be available at the powered device, as some power is dissipated in the cable.

The updated IEEE 802.3at-2009 PoE standard, also known as PoE+ or PoE plus, provides up to 25.5 W of power. The 2009 standard prohibits a powered device from using all four pairs for power. Some vendors have announced products that claim to be compatible with the 802.3at standard and offer up to 51 W of power over a single cable by utilizing all four pairs in the Cat.5 cable.

Numerous non-standard schemes had been used prior to PoE standardization to provide power over Ethernet cabling. Some are still in active use.

This technology is especially useful for powering IP telephones, wireless LAN access points, cameras with pan tilt and zoom (PTZ), remote Ethernet switches, embedded computers, thin clients and LCDs.

All of these devices require more power than USB offers and very often must be powered over longer runs of cable than USB permits. Field-spliced outdoor category 5 Ethernet cable can power radios and other low-power devices, for instance, through over 100 m of cable, an order of magnitude further than USB's theoretical maximums.

In addition, PoE uses only one type of connector, an 8P8C modular connector (often called RJ45), whereas there are numerous types of USB connectors and each new USB standard has added more.

PoE is presently deployed in applications where USB is unsuitable and where AC power would be inconvenient, expensive or infeasible to supply.

However, even where USB or AC power could be used, PoE has several advantages over either, including:

1) Cheaper cabling—even high quality outdoor category 5 cable is much cheaper than USB repeaters or AC wire. The task of meeting building code requirements to run AC power cable safely is eliminated.

2) A true gigabit connection to every device is possible, which exceeds USB 2.0 (400 Mbps) and current (as of 2011, 450 Mbps) AC powerline networking capabilities, and can be teamed for 2-gigabit or 4-gigabit speeds comparable to USB 3.0 throughput. A 10 Gigabit Power over Ethernet standard is also being created.

3) Global organizations can deploy PoE everywhere without concern for any local variance in AC power standards, outlets, plugs, or reliability. This makes a single standard office configuration much easier to maintain, monitor and update based on one standard plan.

4) Direct injection from standard 48 V DC battery power arrays. This enables critical infrastructure to run more easily in outages, and make power rationing decisions centrally for all the PoE devices. The priority for power-supply via PoE can be configured via the switches.

5) Cheap reliable switching. While USB devices require a true computer or router to control the bus, and still require switching or routing to make VPN or Internet connections, powered Ethernet devices require only a switch, which can be unmanaged, to do both jobs. Further, the experience of ISPs, Carrier Ethernet and a number of other qualities of service standards from the Ethernet world are directly applicable to the power-over-Ethernet world, whereas there is no comparable experience base for USB networking

6) Symmetric distribution is possible. Unlike USB and AC outlets, power can be supplied at either end of the cable or outlet. This means the location of the power source can be determined after cables and outlets are installed.

PoE Terminology—Power sourcing equipment (PSE) is a device such as a switch that provides (“sources”) power on the Ethernet cable. The maximum allowed continuous output power per cable in IEEE 802.3af is 15.40 W. A later specification, IEEE 802.3at, offers 25.50 W.

When the device is a switch, it's called an endspan. Otherwise, if it's an intermediary device between a non PoE capable switch and a PoE device, it's called a midspan. An external PoE injector is a midspan device.

A powered device (PD) is powered by a PSE and thus consumes energy. Examples include wireless access points, IP Phones, and IP cameras.

Many powered devices have an auxiliary power connector for an optional, external, power supply. Depending on the PD design, some, none, or all power can be supplied from the auxiliary port, with the auxiliary port sometimes acting as backup power in case of PoE supplied power failure.

Switch Power Features—Beyond the inherent advantages of an optimized inject-anywhere AC-and-DC cabling infrastructure, the switches themselves often contain “active”, “smart”, or “managed” power management features to further reduce AC draw of all devices combined.

Multi-protocol teaming standards (G.9960, G.hn, and IEEE P1905) and handoff standards (IEEE 802.21) generally rely on simulating Ethernet features in other media. These standards enable more optimal energy and bandwidth management solutions than would otherwise be possible. For instance, networking on existing AC power lines to an outlet where a PoE router is plugged, making it capable of moving a gigabit per second to every device, with minimal wiring, participating fully in both AC and DC device power demand management. Or, letting a session migrate from a high-power Ethernet switch to a low-power Power-over-Ethernet wireless routing when the need for bandwidth is low and there is no need for power on the Ethernet cable to be supplied to the device.

Managed switches with both powered and unpowered Ethernet ports feature many significant energy management features, some of which are proprietary but are likely to migrate into the eventual standard. For instance, “auto power-down and cable-length detection” allowing lower signal strength to be used. Given that such features were available in switches selling for under US $250, power savings alone could justify some users switching to a security, VoIP or wireless AP infrastructure based on power over Ethernet, as they would pay for it very quickly.

Power advantages are a major sales appeal of powered over unpowered Ethernet or unpowered alternatives, such as strictly wireless sensor networks, which must in practice rely on batteries if they draw more than their own solar capacity.

Standard Implementation—Standards-based power over Ethernet is implemented following the specifications in IEEE 802.3af-2003 (which was later incorporated as clause 33 into IEEE 802.3-2005) or the 2009 update, IEEE 802.3at. A phantom power technique is used to allow the powered pairs to also carry data. This permits its use not only with 10 BASE-T and 100 BASE-TX, which use only two of the four pairs in the cable, but also with 1000 BASE-T (gigabit Ethernet), which uses all four pairs for data transmission. This is possible because all versions of Ethernet over twisted pair cable specify differential data transmission over each pair with transformer coupling. The DC supply and load connections can be made to the transformer center-taps at each end. Each pair thus operates in common mode as one side of the DC supply, so two pairs are required to complete the circuit. The polarity of the DC supply may be inverted by crossover cables; the powered device must operate with either pair: spare pairs 4-5 and 7-8 or data pairs 1-2 and 3-6. Polarity is required on data pairs, and ambiguously implemented for spare pairs, with the use of a diode bridge.

Two modes, A and B, are available. Mode A delivers phantom power on the data pairs of 100 BASE-TX or 10 BASE-T. Mode B delivers power on the spare pairs. PoE can also be used on 1000 BASE-T Ethernet in which case, there are no spare pairs and all power is delivered using the phantom technique.

Mode A has two alternate configurations (MDI and MDI-X), using the same pairs but with different polarities. In mode A, pins 1 and 2 (pair #2 in T568B wiring) form one side of the 48 V DC, and pins 3 and 6 (pair #3 in T568B) form the other side. These are the same two pairs used for data transmission in 10 BASE-T and 100 BASE-TX, allowing the provision of both power and data over only two pairs in such networks. The free polarity allows PoE to accommodate for crossover cables, patch cables and auto-MDIX.

In mode B, pins 4-5 (pair #1 in both T568A and T568B) form one side of the DC supply and pins 7-8 (pair #4 in both T568A and T568B) provide the return; these are the “spare” pairs in 10 BASE-T and 100 BASE-TX. Mode B, therefore, requires a 4-pair cable.

The PSE, not the powered device (PD), decides whether power mode A or B shall be used. PDs that implement only Mode A or Mode B are disallowed by the standard.

The PSE can implement mode A or B or both. A PD indicates that it is standards-compliant by placing a 25 kΩ resistor between the powered pairs. If the PSE detects a resistance that is too high or too low (including a short circuit), no power is applied. This protects devices that do not support PoE. An optional “power class” feature allows the PD to indicate its power requirements by changing the sense resistance at higher voltages. To stay powered, the PD must continuously use 5-10 mA for at least 60 ms with no more than 400 ms since last use or else it will be unpowered by the PSE.

There are two types of PSEs: endspans and midspans. Endspans are Ethernet switches that include the power over Ethernet transmission circuitry. Endspans are commonly called PoE switches. Midspans are power injectors that stand between a regular Ethernet switch and the powered device, injecting power without affecting the data.

Endspans are normally used on new installations or when the switch has to be replaced for other reasons (such as moving from 10/100 Mbit/s to 1 Gbit/s or adding security protocols), which makes it convenient to add the PoE capability. Midspans are used when there is no desire to replace and configure a new Ethernet switch, and only PoE needs to be added to the network.

Class 4 can only be used by IEEE 802.3at (type 2) devices, requiring valid Class 2 and Mark 2 currents for the power up stages. An 802.3af device presenting a class 4 current is considered non-compliant and, instead, will be treated as a Class 0 device.

Until now, traditional PoE has not been applied to powering, controlling, and communicating with LED lights.

What is needed is a system, method, and apparatus to solve this, and other problems.

### OBJECTS AND FEATURES OF THE INVENTION

It is an object of the present invention to provide a smart grid system, method, and apparatus for powering, controlling, and communicating with light emitting diode (LED) lights using Modified Power over Ethernet (PoE) devices.

### BRIEF DESCRIPTION OF THE FIGURES

FIG. 1 is a diagram of the present invention configured for Smart Building use.

FIG. 2 is an alternative embodiment of the present invention.

FIG. 3 is an alternative embodiment of the present invention.

### SUMMARY OF THE INVENTION

The present invention relates to a smart grid system, method, and apparatus for powering, controlling, and communicating with light emitting diode (LED) lights using Modified Power over Ethernet (M-PoE).

The present invention's system uses M-PoE equipment vs. traditional PoE equipment, which includes capabilities such as, but not limited to, the added capability for PoE ports to be turned on-off in response to a signal, and to be have a PoE port's output voltage regulated in response to a signal. M-PoE equipment includes PSE and PD equipment configured such as, but not limited to, mid-spans, end-spans, etc.

The present invention's smart grid is a digitally enabled local (in-building, campus-wide) electrical power distribution grid that is enabled to gather, distribute, and act on information about the behavior of all attached devices, including schedules, time of day, season, occupancy, etc., in order to improve the efficiency, reliability, and economics of electricity services. In addition, the present invention's smart grid may also communicate with the larger smart grid, and also may be controlled by the larger smart grid.

### DETAILED DESCRIPTION OF THE PRESENT INVENTION

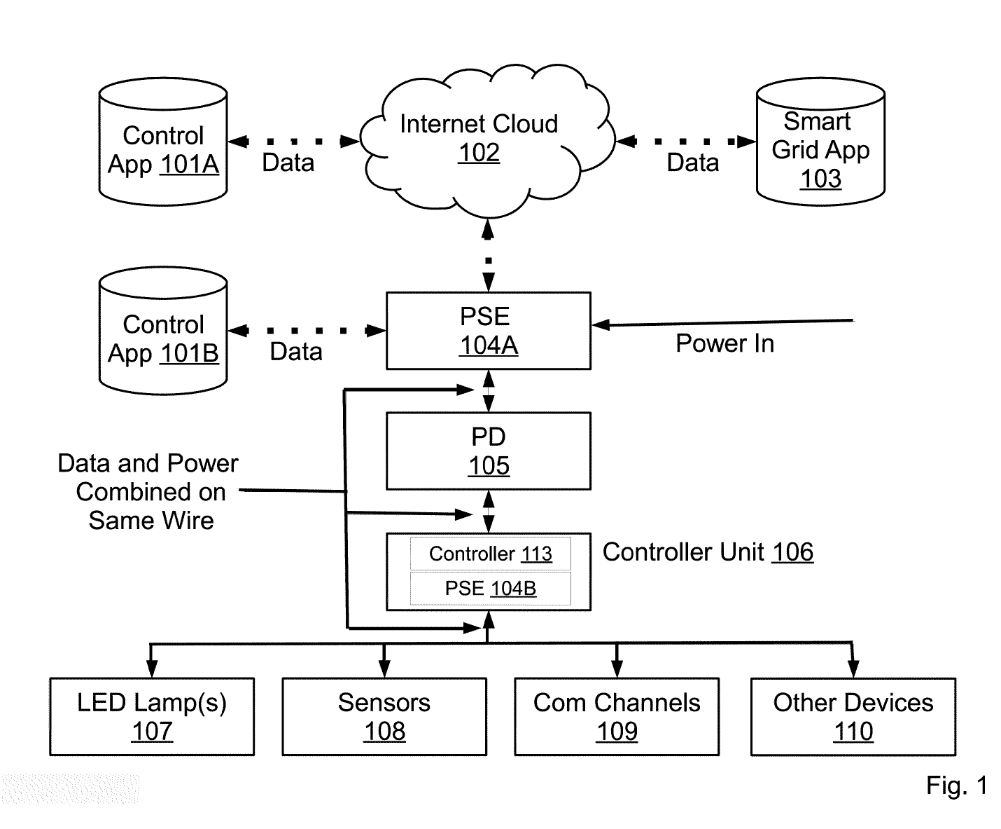

FIG. 1 is an illustration of the present invention.

Control App 101A is a program that resides on at least one computer, and is shown as accessible via a network, such as, but not limited to Internet Cloud 102. Control App 101A operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Control App 101A can send instructions to Controller Unit 106 to operate at least one LED Lamp 107; optionally, at least one Sensor 108; optionally at least one Communication Channel 109; and optionally Other Devices 110.

Control App 101B is a program that resides on at least one computer, and is shown as accessible via the same local network PSE 104A is part of. Control App 101B operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Control App 101B can send instructions to Controller Unit 106 to operate at least one LED Lamp 107; and optionally, at least one Sensor 108; at least one Communication Channel 109; and Other Devices 110.

Internet Cloud 102 is a global system of interconnected computer networks that use the standard Internet protocol suite (TCP/IP) to serve billions of users worldwide. This network of networks consists of millions of private, public, academic, business, and government networks, that are local to global in scope, linked by a broad array of electronic, wireless and optical networking technologies. The Internet carries a vast range of information resources and services.

Smart Grid App 103 is a program that resides on at least on computer, and is shown as accessible via a network, such as, but not limited to Internet Cloud 102. Smart Grid App 103 operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Smart Grid App 103 is capable of working in conjunction with Control App 101A. Control App 101A can send instructions to Controller Unit 106 to operate at least one LED Lamp 107; optionally, at least one Sensor 108; optionally at least one Communication Channel 109; and optionally Other Devices 110.

Power Sourcing Equipment (PSE) 104A is a device, such as, but not limited to a switch. PSE 104A transmits/receives data, and sources power, which are combined on an Ethernet cable that feeds PD 105, Controller Unit 106, LED Lamps 107, and optional Sensors 108, Com Channels 109, and Other Devices 110. Currently, the maximum allowed continuous output power per cable in IEEE 802.3af is 15.40 W. A later specification, IEEE 802.3at, offers 25.50 W. When a PSE 104A device is a switch, it's called an endspan in PoE vernacular. Otherwise, if it's an intermediary device between a non-PoE capable switch and a PoE device, it's called a midspan. An external PoE injector is a midspan device. PSE 104A is M-PoE equipment, which has been configured to turn a specific port on-off, or to vary a specific port voltage to achieve dimming effects at an LED light.

As an example, a typical 48-port Ethernet switch has a 50 W to 80 W power supply allocated for the traditional Ethernet switch and transceiver integrated circuits. Over and above this for PoE, typically a 370 W (for IEEE 802.3af) to 740 W (for IEEE 802.3at) power supply is allocated solely for PoE ports, permitting a maximum draw on each. This can be quite inefficient to supply through long cables. However, where this central supply replaces several dedicated AC circuits, transformers and inverters, and prevents expensive human interventions (AC installations) the power loss of long thin DC cable is easily justifiable. Power can always be introduced on the device end of the Ethernet cable (radically improving efficiency) where AC power is available. The M-PoE equipment used in the present invention is configured to turn a specific port on-off, or to vary a specific port voltage to achieve dimming effects at an LED light.

Powered Device (PD) 105 is powered by PSE 104A. Some examples of PDs include, but is not limited to, wireless access points, IP Phones, IP cameras, etc.

Many types of Powered Devices have an auxiliary power connector for an optional, external, power supply. Depending on the PD design, some, none, or all power can be supplied from an auxiliary port, with the auxiliary port sometimes acting as backup power in case of PoE supplied power failure. PD 105 is M-PoE equipment, which has been configured to turn a specific port on-off, or to vary a specific port voltage to achieve dimming effects at an LED light.

Currently, two standard PoE modes, A and B, are available. Mode A delivers phantom, power on the data pairs of 100 BASE-TX or 10 BASE-T. Mode B delivers power on the spare pairs. PoE can also be used on 1000 BASE-T Ethernet in which case, there are no spare pairs and all power is delivered using the phantom technique.

Mode A has two alternate configurations (MDI and MDI-X), using the same pairs but with different polarities. In mode A, pins 1 and 2 (pair #2 in T568B wiring) form one side of the 48 V DC, and pins 3 and 6 (pair #3 in T568B) form the other side. These are the same two pairs used for data transmission in 10 BASE-T and 100 BASE-TX, allowing the provision of both power and data over only two pairs in such networks. The free polarity allows PoE to accommodate for crossover cables, patch cables and auto-MDIX.

In mode B, pins 4-5 (pair #1 in both T568A and T568B) form one side of the DC supply and pins 7-8 (pair #4 in both T568A and T568B) provide the return; these are the “spare” pairs in 10 BASE-T and 100 BASE-TX. Mode B, therefore, requires a 4-pair cable.

PSE 104A, not PD 105, determines whether power mode A or B shall be used. A PD that implements only Mode A or Mode B are disallowed by the standard.

PSE 104A can implement mode A or B or both. PD 105 indicates that it is standards-compliant device by placing a 25 kΩ resistor between the powered pairs. If PSE 104A detects a resistance that is too high or too low (including a short circuit), no power is applied. This protects devices that do not support PoE. An optional “power class” feature allows PD 105 to indicate its power requirements by changing the sense resistance at higher voltages. To stay powered, PD 105 must continuously use 5-10 mA for at least 60 ms with no more than 400 ms since last use or else it will be unpowered by PSE 104A.

Data can be encapsulated in Ethernet packets in the present invention using a wide variety of protocols such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2x, PCI 64/66, Ultra-640 SCSI, AGP 4x, PCI-X 133, InfiniBand, PCI Express (x4 link), AGP 8x, PCI-X DDR, HyperTransport (800 MHz, 16-pair), PCI Express (x16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit Ethernet WAN PHY, 10 Gigabit Ethernet LAN PHY, OC256, and OC768, LocalTalk, ARCNET, Token Ring, Ethernet (10 base-X), Fast Ethernet (100 base-X), FDDI, and Gigabit Ethernet (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, Ethernet (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, backplane protocols including, but not limited to, VMEbus, PC 104A, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor busses including, but not limited to, Fast Simplex Link (FSL), On-chip Peripheral Bus (OPB), Local Memory Bus (LMB), and Xilinx PowerPC microprocessor busses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Controller Unit 106 is the interface between PD 105 and LED Lamps 107; optional Sensors 108, Com Channels 109, and Other Devices 110. Controller Unit 106 is a digital computer used for automation of electromechanical processes, such as, but not limited to, control of machinery, LED light fixtures, etc. Controller Unit 106 is shown configured with Controller 113 for receiving operating instructions from Control App 101A and/or Control App 101B and/or Smart Grid App 103 for controlling LED Lamps 107, optional Sensors 108, Com Channels 109, and Other Devices 110. Controller Unit 106 can include wireless communication capabilities as well. Furthermore, Controller Unit 106 can be configured to look like a wall light switch, except instead of being directly connected to an LED light, it is connected to Control App 101A and/or Control App 101B and/or Smart Grid App 103, which in turn send commands to M-PoE PD or PSE equipment to turn a specific port on-off, or to vary a specific port voltage to achieve dimming effects at an LED light.

In addition, Controller Unit 106 includes an integrated PSE 104B for the distribution of power, and the transmission/receipt of data. In FIG. 1, optional Sensors 108, Com Channels 109, and Other Devices 110 receive power directly from Controller Unit 106, and transmit/receive data directly from the endspan PSE embedded in Controller Unit 106.

LED Lamps 107 are solid-state, and use light-emitting diodes (LEDs) as the source of light. The LEDs involved may be devices such as, but not limited to, conventional semiconductor light-emitting diodes, organic LEDs (OLED), or polymer light-emitting diodes (PLED) devices, although PLED technologies are not generally commercially available.

Optional Sensors 108 are devices that measure a physical quantity and convert it into a signal which can be read by an observer or by an instrument. For example, a thermocouple converts temperature to an output voltage which can be read by a voltmeter. Examples of optional Sensors 108 include, but are not limited to, microphones, carbon dioxide sensors, carbon monoxide detectors, chemical field-effect transistors, electrochemical gas sensors, holographic sensors, infrared sensors, nondispersive infrared sensors, microwave chemistry sensors, nitrogen oxide sensor, olfactometers, optodes, oxygen sensors, pellistors, potentiometric sensors, redox electrodes, smoke detectors, zinc oxide nanorod sensors, electric current meters, electric potential, magnetic sensors, ammeters, current sensors, galvanometers, hall effect sensors, magnetic anomaly detector, magnetometers, MEMS magnetic field sensors, metal detectors, multimeters, ohmmeters, radio direction finders, voltmeters, voltage detectors, watt-hour meters, humidity sensors, air flow meters, Geiger counters, neutron detectors, photoelectric sensors, motion detectors, charge-coupled devices, calorimeters, electro-optical sensors, flame detectors, kinetic inductance detectors, LEDs as light sensors, light-addressable potentiometric sensors, Nichols radiometers, fiber optic sensors, photodetectors, photodiodes, phototransistors, photoelectric sensors, photoionization detector, photomultipliers, photoresistors, photoswitches, phototubes, scintillometers, visible light photon counters, barometers, pressure sensors, load cells, magnetic level gauges, strain gauges, bolometers, bi-metallic strips, infrared thermometers, microbolometers, microwave radiometers, net radiometers, quartz thermometers, resistance temperature detectors, resistance thermometers, silicon bandgap temperature sensors, thermistors, thermocouples, thermometers, alarm sensors, occupancy sensors, proximity sensors, passive infrared sensors, reed switches, triangulation sensors, bio-sensors, radar, ground penetrating radar, synthetic aperture radar. These sensors may use technology such as, but not limited to, active pixel sensors, back-illuminated sensors, catadioptric sensors, carbon paste electrodes, displacement receivers, electromechanical film, electro-optical sensors, Fabry-Pérot interferometers, image sensors, inductive sensors, machine vision technology. microelectromechanical systems, micro-sensor arrays, photoelasticity, sensor fusion, sensor grids, sensor nodes, sonar, transducers, ultrasonic sensors, video sensors, visual sensor networks, Wheatstone bridges, wireless sensor networks, frame grabbers, intensity sensors, chemoreceptors, compressive sensing, hyperspectral sensors, millimeter wave scanners, magnetic resonance imaging, diffusion tensor imaging, functional magnetic resonance imaging, molecular sensors, etc.

Optional Com Channels 109 (Communication Channels) in telecommunications and computer networking, refers either to a physical transmission medium such as a wire, or to a logical connection over a multiplexed medium such as a radio channel. A channel is used to convey an information signal, for example a digital bit stream, from one or several transmitters, to at least one receiver. A channel has a certain capacity for transmitting information, often measured by its bandwidth in Hz or its data rate in bits per second. The channels can be analog, digital, multiplexed, shared, point-to-point, simplex, duplex, half-duplex, broadcast, unicast, multi-cast, etc. Information is carried through the channel via a signal. The signal can be transmitted/received using a wide variety of protocols, such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2x, PCI 64/66, Ultra-640 SCSI, AGP 4x, PCI-X 133, InfiniBand, PCI Express (x4 link), AGP 8x, PCI-X DDR, HyperTransport (800 MHz, 16-pair), PCI Express (x16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit Ethernet WAN PHY, 10 Gigabit Ethernet LAN PHY, OC256, and OC768, LocalTalk, ARCNET, Token Ring, Ethernet (10 base-X), Fast Ethernet (100 base-X), FDDI, and Gigabit Ethernet (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, Ethernet (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, backplane protocols including, but not limited to, VMEbus, PC 104, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor busses including, but not limited to, Fast Simplex Link (FSL), On-chip Peripheral Bus (OPB), Local Memory Bus (LMB), and Xilinx PowerPC microprocessor busses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Interfaces for the optional Communication Channel 109 to transmit/receive data via standard audio, video, and computer equipment jack and ports include, but are not limited to: connectors for twisted pair cable include the modular RJ type of jacks and plugs (RJ-11; RJ-14; RJ-22; RJ-25; RJ-31; RJ-45; RJ-48; RJ-61) (of four, six, and eight position configurations) along with the hermaphroditic connector employed by IBM. The hermaphroditic connector is specific to STP and is also known as STP connector, IBM data connector, or universal data connector. The connector used with patch panels, punch-down blocks, and wall plates, is called an IDC (insulated displacement connector). Modular Y-adapters used for splitting usually in 10 Base-T, Token Ring, and voice applications. Also, crossover cables which are wired to a T586A pinout scheme on one end and a T586B pinout on the other end. Coax connectors used with video equipment are referred to as F-series connectors (primarily used in residential installations for RG-58, RG-59, and RG-6 coaxial cables). Coax cables used with data and video backbone applications use N-connectors (used with RG-8, RJ-11U, and thicknet cables). When coaxial cable distributes data in commercial environments, the BNC (Bayonet Niell-Concelman) connector is often used. It is used with RG-6, RG-58A/U thinnet, RG-59, and RG-62 coax cable. Fiber-optic connectors include SC, duplex SC, ST, duplex ST, FDDI, and FC. These relate to different types of fiber-optic cables and configurations. Three of the SFF connectors that have recently been propagated (for fiber-optic cables are LC, VF-45, and the MT-RJ, etc.

Other Devices 110 can include technology such as, but not limited to, Radio Frequency Identification (RFID) readers, barcode readers, cameras, wired and wireless switches, wired and wireless routers, wired and wireless hubs, alarms, femto-cells, pico-cells, micro-cells, smart card readers, etc.

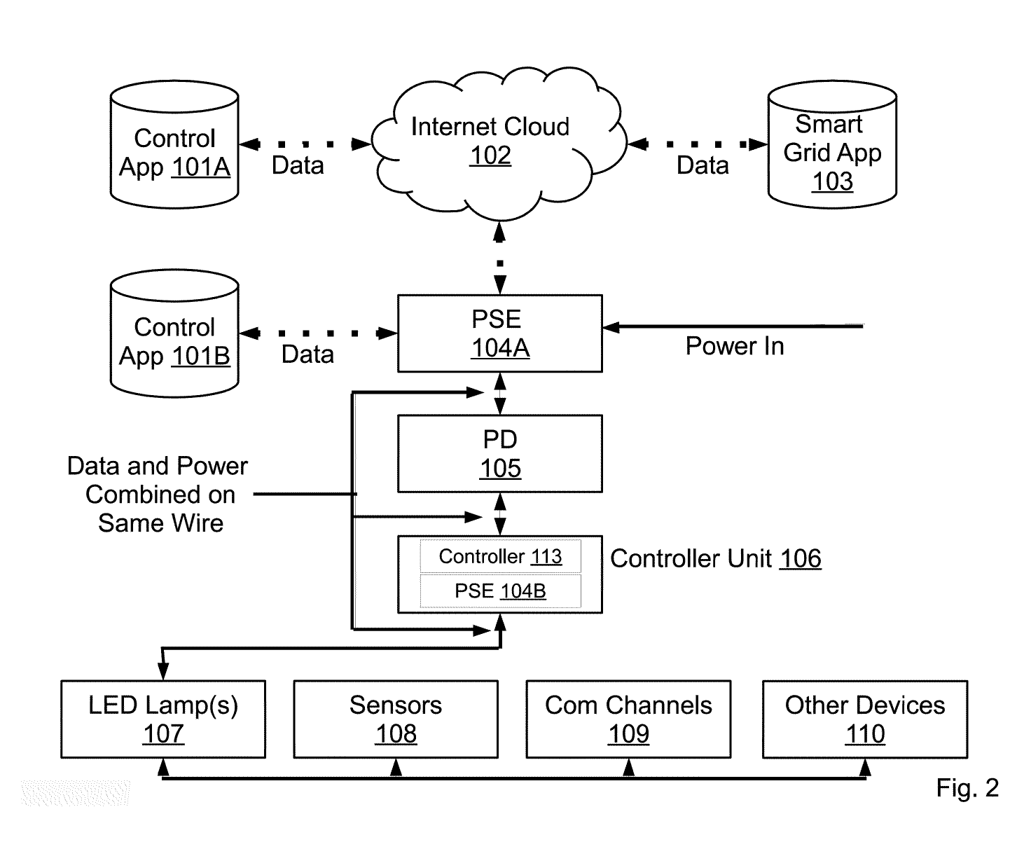

FIG. 2 is an illustration of an alternative embodiment of the present invention.

Control App 101A is a program that resides on at least one computer, and is shown as accessible via a network, such as, but not limited to Internet Cloud 102. Control App 101A operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Control App 101A can send instructions to Controller Unit 106 to operate at least one LED Lamp 107; optionally, at least one Sensor 108; optionally at least one Communication Channel 109; and optionally Other Devices 110.

Control App 101B is a program that resides on at least one computer, and is shown as accessible via the same local network PSE 104A is part of. Control App 101B operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Control App 101B can send instructions to Controller Unit 106 to operate at least one LED Lamp 107; and optionally, at least one Sensor 108; at least one Communication Channel 109; and Other Devices 110.

Internet Cloud 102 is a global system of interconnected computer networks that use the standard Internet protocol suite (TCP/IP) to serve billions of users worldwide. This network of networks consists of millions of private, public, academic, business, and government networks, that are local to global in scope, linked by a broad array of electronic, wireless and optical networking technologies. The Internet carries a vast range of information resources and services.

Smart Grid App 1023 is a program that resides on at least on computer, and is shown as accessible via a network, such as, but not limited to Internet Cloud 102. Smart Grid App 103 operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Smart Grid App 102 is capable of working in conjunction with Control App 101A. Control App 101A can send instructions to Controller Unit 106 to operate at least one LED Lamp 107; optionally, at least one Sensor 108; optionally at least one Communication Channel 109; and optionally Other Devices 110.

Power Sourcing Equipment (PSE) 104A, previously described in FIG. 1, is a device, such as, but not limited to a switch. PSE 104A transmits/receives data, and sources power, which are combined on an Ethernet cable that feeds PD 105, Controller Unit 106, LED Lamps 107, and optional Sensors 108, Com Channels 109, and Other Devices 110. Currently, the maximum allowed continuous output power per cable in IEEE 802.3af is 15.40 W. A later specification, IEEE 802.3at, offers 25.50 W. When a PSE device is a switch, it's called an endspan in PoE vernacular. Otherwise, if it's an intermediary device between a non-PoE capable switch and a PoE device, it's called a midspan. An external PoE injector is a midspan device. PSE 104A is M-PoE equipment, which has been configured to turn a specific port on-off, or to vary a specific port voltage to achieve dimming effects at an LED light.

As an example, a typical 48-port Ethernet switch has a 50 W to 80 W power supply allocated for the traditional Ethernet switch and transceiver integrated circuits. Over and above this for PoE, typically a 370 W (for IEEE 802.3af) to 740 W (for IEEE 802.3at) power supply is allocated solely for PoE ports, permitting a maximum draw on each. This can be quite inefficient to supply through long cables. However, where this central supply replaces several dedicated AC circuits, transformers and inverters, and prevents expensive human interventions (AC installations) the power loss of long thin DC cable is easily justifiable. Power can always be introduced on the device end of the Ethernet cable (radically improving efficiency) where AC power is available. The M-PoE equipment used in the present invention is configured to turn a specific port on-off, or to vary a specific port voltage to achieve dimming effects at an LED light.

Powered Device (PD) 105 is powered by PSE 104A. Some examples of PDs include, but is not limited to, wireless access points, IP Phones, IP cameras, etc.

Many types of Powered Devices have an auxiliary power connector for an optional, external, power supply. Depending on the PD design, some, none, or all power can be supplied from an auxiliary port, with the auxiliary port sometimes acting as backup power in case of PoE supplied power failure. PD 105 is M-PoE equipment, which has been configured to turn a specific port on-off, or to vary a specific port voltage to achieve dimming effects at an LED light.

Powered Device (PD) 105 is powered by PSE 104A. Some examples of PDs include, but is not limited to, wireless access points, IP Phones, IP cameras, etc.

Many types of Powered Devices have an auxiliary power connector for an optional, external, power supply. Depending on the PD design, some, none, or all power can be supplied from an auxiliary port, with the auxiliary port sometimes acting as backup power in case of PoE supplied power failure.

Currently, two standard PoE modes, A and B, are available. Mode A delivers phantom, power on the data pairs of 100 BASE-TX or 10 BASE-T. Mode B delivers power on the spare pairs. PoE can also be used on 1000 BASE-T Ethernet in which case, there are no spare pairs and all power is delivered using the phantom technique.

Mode A has two alternate configurations (MDI and MDI-X), using the same pairs but with different polarities. In mode A, pins 1 and 2 (pair #2 in T568B wiring) form one side of the 48 V DC, and pins 3 and 6 (pair #3 in T568B) form the other side. These are the same two pairs used for data transmission in 10 BASE-T and 100 BASE-TX, allowing the provision of both power and data over only two pairs in such networks. The free polarity allows PoE to accommodate for crossover cables, patch cables and auto-MDIX.

In mode B, pins 4-5 (pair #1 in both T568A and T568B) form one side of the DC supply and pins 7-8 (pair #4 in both T568A and T568B) provide the return; these are the “spare” pairs in 10 BASE-T and 100 BASE-TX. Mode B, therefore, requires a 4-pair cable.

PSE 104A, not PD 105, determines whether power mode A or B shall be used. A PD that implements only Mode A or Mode B are disallowed by the standard.

PSE 104A can implement mode A or B or both. PD 105 indicates that it is standards-compliant device by placing a 25 kΩ resistor between the powered pairs. If PSE 104A detects a resistance that is too high or too low (including a short circuit), no power is applied. This protects devices that do not support PoE. An optional “power class” feature allows PD 105 to indicate its power requirements by changing the sense resistance at higher voltages. To stay powered, PD 105 must continuously use 5-10 mA for at least 60 ms with no more than 400 ms since last use or else it will be unpowered by PSE 104A.

Data can be encapsulated in Ethernet packets in the present invention using a wide variety of protocols such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2x, PCI 64/66, Ultra-640 SCSI, AGP 4x, PCI-X 133, InfiniBand, PCI Express (x4 link), AGP 8x, PCI-X DDR, HyperTransport (800 MHz, 16-pair), PCI Express (x16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit Ethernet WAN PHY, 10 Gigabit Ethernet LAN PHY, OC256, and OC768, LocalTalk, ARCNET, Token Ring, Ethernet (10 base-X), Fast Ethernet (100 base-X), FDDI, and Gigabit Ethernet (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, Ethernet (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, backplane protocols including, but not limited to, VMEbus, PC 104A, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor busses including, but not limited to, Fast Simplex Link (FSL), On-chip Peripheral Bus (OPB), Local Memory Bus (LMB), and Xilinx PowerPC microprocessor busses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Controller Unit 106 is the interface between PD 105 and LED Lamps 107; optional Sensors 108, Com Channels 109, and Other Devices 110. Controller Unit 106 is a digital computer used for automation of electromechanical processes, such as, but not limited to, control of machinery, LED light fixtures, etc. Controller Unit 106 is shown configured with Controller 113 for receiving operating instructions from Control App 101A and/or Control App 101B and/or Smart Grid App 103 for controlling LED Lamps 107, optional Sensors 108, Com Channels 109, and Other Devices 110. Controller Unit 106 can include wireless communication capabilities as well. Furthermore, Controller Unit 106 can be configured to look like a wall light switch, except instead of being directly connected to an LED light, it is connected to Control App 101A and/or Control App 101B and/or Smart Grid App 103, which in turn send commands to M-PoE PD or PSE equipment to turn a specific port on-off, or to vary a specific port voltage to achieve dimming effects at an LED light.

In FIG. 2, optional Sensors 108, Com Channels 109, and Other Devices 110 receive power directly from Controller Unit 106, and transmit/receive data directly from the ends and PSE embedded in Controller Unit 106.

LED Lamps 107 are solid-state, and use light-emitting diodes (LEDs) as the source of light. The LEDs involved may be devices such as, but not limited to, conventional semiconductor light-emitting diodes, organic LEDs (OLED), or polymer light-emitting diodes (PLED) devices, although PLED technologies are not generally commercially available.

Optional Sensors 108 are devices that measure a physical quantity and convert it into a signal which can be read by an observer or by an instrument. Instead of being directly connected to Controller Unit 106 as shown in FIG. 1, optional Sensors 108 are connected to LED Lamps 107 for data transmission/receipt and power sourcing. For example, a thermocouple converts temperature to an output voltage which can be read by a voltmeter. Examples of optional Sensors 108 that may be included, include, but are not limited to, microphones, carbon dioxide sensors, carbon monoxide detectors, chemical field-effect transistors, electrochemical gas sensors, holographic sensors, infrared sensors, nondispersive infrared sensors, microwave chemistry sensors, nitrogen oxide sensor, olfactometers, optodes, oxygen sensors, pellistors, potentiometric sensors, redox electrodes, smoke detectors, zinc oxide nanorod sensors, electric current meters, electric potential, magnetic sensors, ammeters, current sensors, galvanometers, hall effect sensors, magnetic anomaly detector, magnetometers, MEMS magnetic field sensors, metal detectors, multimeters, ohmmeters, radio direction finders, voltmeters, voltage detectors, watt-hour meters, humidity sensors, air flow meters, Geiger counters, neutron detectors, photoelectric sensors, motion detectors, charge-coupled devices, calorimeters, electro-optical sensors, flame detectors, kinetic inductance detectors, LEDs as light sensors, light-addressable potentiometric sensors, Nichols radiometers, fiber optic sensors, photodetectors, photodiodes, phototransistors, photoelectric sensors, photoionization detector, photomultipliers, photoresistors, photoswitches, phototubes, scintillometers, visible light photon counters, barometers, pressure sensors, load cells, magnetic level gauges, strain gauges, bolometers, bi-metallic strips, infrared thermometers, microbolometers, microwave radiometers, net radiometers, quartz thermometers, resistance temperature detectors, resistance thermometers, silicon bandgap temperature sensors, thermistors, thermocouples, thermometers, alarm sensors, occupancy sensors, proximity sensors, passive infrared sensors, reed switches, triangulation sensors, bio-sensors, radar, ground penetrating radar, synthetic aperture radar. These sensors may use technology such as, but not limited to, active pixel sensors, back-illuminated sensors, catadioptric sensors, carbon paste electrodes, displacement receivers, electromechanical film, electro-optical sensors, Fabry-Pérot interferometers, image sensors, inductive sensors, machine vision technology. microelectromechanical systems, micro-sensor arrays, photoelasticity, sensor fusion, sensor grids, sensor nodes, sonar, transducers, ultrasonic sensors, video sensors, visual sensor networks, Wheatstone bridges, wireless sensor networks, frame grabbers, intensity sensors, chemoreceptors, compressive sensing, hyperspectral sensors, millimeter wave scanners, magnetic resonance imaging, diffusion tensor imaging, functional magnetic resonance imaging, molecular sensors, etc.

Optional Com Channels 109 (Communication Channels) in telecommunications and computer networking, refers either to a physical transmission medium such as a wire, or to a logical connection over a multiplexed medium such as a radio channel. Instead of being directly connected to Controller Unit 106 as shown in FIG. 1, optional communication Channels 109 are connected to LED Lamps 107 for data transmission/receipt and power sourcing. A channel is used to convey an information signal, for example a digital bit stream, from one or several transmitters, to at least one receiver. A channel has a certain capacity for transmitting information, often measured by its bandwidth in Hz or its data rate in bits per second. The channels can be analog, digital, multiplexed, shared, point-to-point, simplex, duplex, half-duplex, broadcast, unicast, multi-cast, etc. Information is carried through the channel via a signal. The signal can be transmitted/received using a wide variety of protocols, such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2x, PCI 64/66, Ultra-640 SCSI, AGP 4x, PCI-X 133, InfiniBand, PCI Express (x4 link), AGP 8x, PCI-X DDR, HyperTransport (800 MHz, 16-pair), PCI Express (x16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit Ethernet WAN PHY, 10 Gigabit Ethernet LAN PHY, OC256, and OC768, LocalTalk, ARCNET, Token Ring, Ethernet (10 base-X), Fast Ethernet (100 base-X), FDDI, and Gigabit Ethernet (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, Ethernet (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, backplane protocols including, but not limited to, VMEbus, PC 104, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor busses including, but not limited to, Fast Simplex Link (FSL), On-chip Peripheral Bus (OPB), Local Memory Bus (LMB), and Xilinx PowerPC microprocessor busses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Interfaces for the optional Communication Channel 109 to transmit/receive data via standard audio, video, and computer equipment jack and ports include, but are not limited to: connectors for twisted pair cable include the modular RJ type of jacks and plugs (RJ-11; RJ-14; RJ-22; RJ-25; RJ-31; RJ-45; RJ-48; RJ-61) (of four, six, and eight position configurations) along with the hermaphroditic connector employed by IBM. The hermaphroditic connector is specific to STP and is also known as STP connector, IBM data connector, or universal data connector. The connector used with patch panels, punch-down blocks, and wall plates, is called an IDC (insulated displacement connector). Modular Y-adapters used for splitting usually in 10 Base-T, Token Ring, and voice applications. Also, crossover cables which are wired to a T586A pinout scheme on one end and a T586B pinout on the other end. Coax connectors used with video equipment are referred to as F-series connectors (primarily used in residential installations for RG-58, RG-59, and RG-6 coaxial cables). Coax cables used with data and video backbone applications use N-connectors (used with RG-8, RJ-11U, and thicknet cables). When coaxial cable distributes data in commercial environments, the BNC (Bayonet Niell-Concelman) connector is often used. It is used with RG-6, RG-58A/U thinnet, RG-59, and RG-62 coax cable. Fiber-optic connectors include SC, duplex SC, ST, duplex ST, FDDI, and FC. These relate to different types of fiber-optic cables and configurations. Three of the SFF connectors that have recently been propagated (for fiber-optic cables are LC, VF-45, and the MT-RJ, etc. Instead of being directly connected to Controller Unit 106 as shown in FIG. 1, optional Other Devices 110 are connected to LED Lamps 107 for data transmission/receipt and power sourcing.

Other Devices 110 can include technology such as, but not limited to, Radio Frequency Identification (RFID) readers, barcode readers, cameras, wired and wireless switches, wired and wireless routers, wired and wireless hubs, alarms, femto-cells, pico-cells, micro-cells, smart card readers, etc.

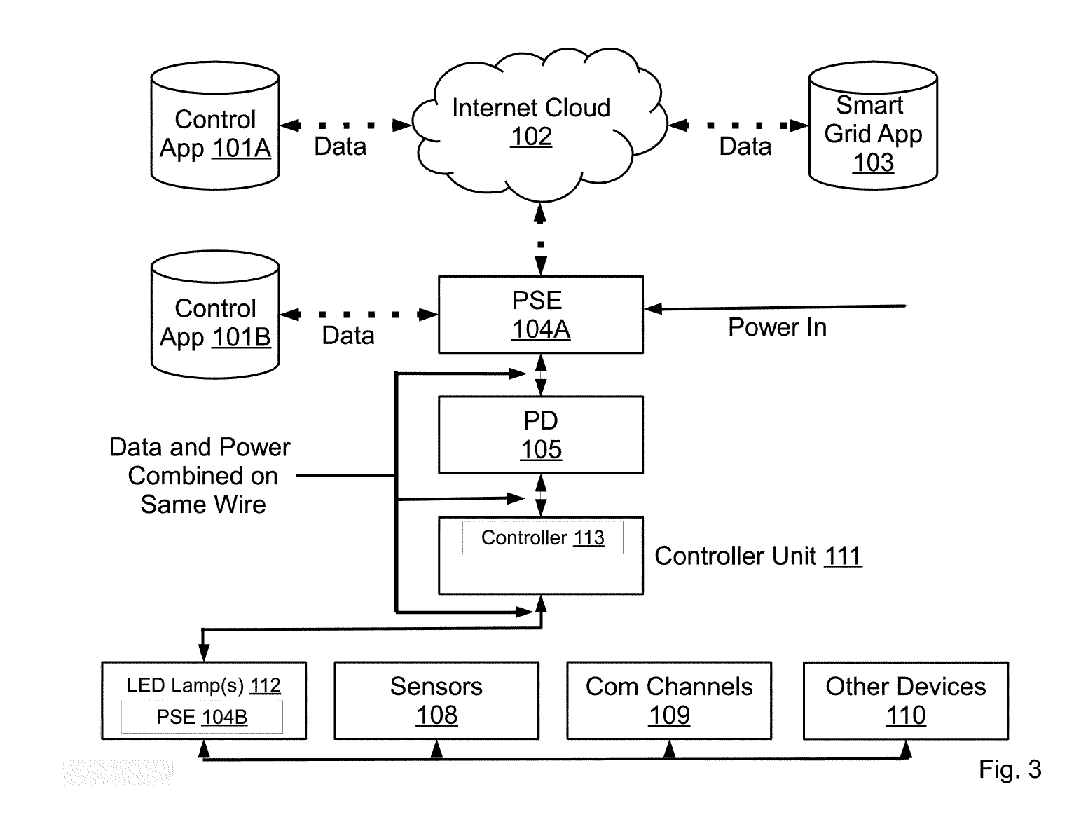

FIG. 3 is an illustration of an alternative embodiment of the present invention.

Control App 101A is a program that resides on at least one computer, and is shown as accessible via a network, such as, but not limited to Internet Cloud 102. Control App 101A operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Control App 101A can send instructions to Controller Unit 111 to operate at least one LED Lamp 107; optionally at least one Sensor 108; optionally at least one Communication Channel 109; and optionally Other Devices 110.

Control App 101B is a program that resides on at least one computer, and is shown as accessible via the same local network PSE 104A is part of. Control App 101B operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Control App 101B can send instructions to Controller Unit 111 to operate at least one LED Lamp 107; and optionally, at least one Sensor 108; at least one Communication Channel 109; and Other Devices 110.

Internet Cloud 102 is a global system of interconnected computer networks that use the standard Internet protocol suite (TCP/IP) to serve billions of users worldwide. This network of networks consists of millions of private, public, academic, business, and government networks, that are local to global in scope, linked by a broad array of electronic, wireless and optical networking technologies. The Internet carries a vast range of information resources and services.

Smart Grid App 103 is a program that resides on at least on computer, and is shown as accessible via a network, such as, but not limited to Internet Cloud 102. Smart Grid App 103 operates on a programmable machine designed to sequentially and automatically carry out a sequence of arithmetic or logical operations. Said programmable machine consists of some form of memory for data storage, at least one element that carries out arithmetic and logic operations, and a sequencing and control element that can change the order of operations based on the information that is stored. Smart Grid App 103 is capable of working in conjunction with Control App 101A. Control App 101A can send instructions to Controller Unit 111 to operate at least one LED Lamp 107; optionally, at least one Sensor 108; optionally at least one Communication Channel 109; and optionally Other Devices 110.

Power Sourcing Equipment (PSE) 104A is a device, such as, but not limited to a switch. PSE 104A transmits/receives data, and sources power, which are combined on an Ethernet cable that feeds PD 105, Controller Unit 106, LED Lamps 107, and optional Sensors 108, Com Channels 109, and Other Devices 110. Currently, the maximum allowed continuous output power per cable in IEEE 802.3af is 15.40 W. A later specification, IEEE 802.3at, offers 25.50 W. When a PSE device is a switch, it's called an endspan in PoE vernacular. Otherwise, if it's an intermediary device between a non-PoE capable switch and a PoE device, it's called a midspan. An external PoE injector is a midspan device. PSE 104A is M-PoE equipment, which has been configured to turn a specific port on-off, or to vary a specific port voltage to achieve dimming effects at an LED light.

As an example, a typical 48-port Ethernet switch has a 50 W to 80 W power supply allocated for the traditional Ethernet switch and transceiver integrated circuits. Over and above this for PoE, typically a 370 W (for IEEE 802.3af) to 740 W (for IEEE 802.3at) power supply is allocated solely for PoE ports, permitting a maximum draw on each. This can be quite inefficient to supply through long cables. However, where this central supply replaces several dedicated AC circuits, transformers and inverters, and prevents expensive human interventions (AC installations) the power loss of long thin DC cable is easily justifiable. Power can always be introduced on the device end of the Ethernet cable (radically improving efficiency) where AC power is available. The M-PoE equipment used in the present invention is configured to turn a specific port on-off, or to vary a specific port voltage to achieve dimming effects at an LED light.

Powered Device (PD) 105 is powered by PSE 104A. Some examples of PDs include, but is not limited to, wireless access points, IP Phones, IP cameras, etc.

Many types of Powered Devices have an auxiliary power connector for an optional, external, power supply. Depending on the PD design, some, none, or all power can be supplied from an auxiliary port, with the auxiliary port sometimes acting as backup power in case of PoE supplied power failure. PD 105 is M-PoE equipment, which has been configured to turn a specific port on-off, or to vary a specific port voltage to achieve dimming effects at an LED light.

Powered Device (PD) 105 is powered by PSE 104A. Some examples of PDs include, but is not limited to, wireless access points, IP Phones, IP cameras, etc.

Many types of Powered Devices have an auxiliary power connector for an optional, external, power supply. Depending on the PD design, some, none, or all power can be supplied from an auxiliary port, with the auxiliary port sometimes acting as backup power in case of PoE supplied power failure.

Currently, two standard PoE modes, A and B, are available. Mode A delivers phantom, power on the data pairs of 100 BASE-TX or 10 BASE-T. Mode B delivers power on the spare pairs. PoE can also be used on 1000 BASE-T Ethernet in which case, there are no spare pairs and all power is delivered using the phantom technique. Mode A has two alternate configurations (MDI and MDI-X), using the same pairs but with different polarities. In mode A, pins 1 and 2 (pair #2 in T568B wiring) form one side of the 48 V DC, and pins 3 and 6 (pair #3 in T568B) form the other side. These are the same two pairs used for data transmission in 10 BASE-T and 100 BASE-TX, allowing the provision of both power and data over only two pairs in such networks. The free polarity allows PoE to accommodate for crossover cables, patch cables and auto-MDIX.

In mode B, pins 4-5 (pair #1 in both T568A and T568B) form one side of the DC supply and pins 7-8 (pair #4 in both T568A and T568B) provide the return; these are the “spare” pairs in 10 BASE-T and 100 BASE-TX. Mode B, therefore, requires a 4-pair cable.

PSE 104A, not PD 105, determines whether power mode A or B shall be used. A PD that implements only Mode A or Mode B are disallowed by the standard.

PSE 104A can implement mode A or B or both. PD 105 indicates that it is standards-compliant device by placing a 25 kΩ resistor between the powered pairs. If PSE 104A detects a resistance that is too high or too low (including a short circuit), no power is applied. This protects devices that do not support PoE. An optional “power class” feature allows PD 105 to indicate its power requirements by changing the sense resistance at higher voltages. To stay powered, PD 105 must continuously use 5-10 mA for at least 60 ms with no more than 400 ms since last use or else it will be unpowered by PSE 104A.

Data can be encapsulated in Ethernet packets in the present invention using a wide variety of protocols such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2x, PCI 64/66, Ultra-640 SCSI, AGP 4x, PCI-X 133, InfiniBand, PCI Express (x4 link), AGP 8x, PCI-X DDR, HyperTransport (800 MHz, 16-pair), PCI Express (x16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit Ethernet WAN PHY, 10 Gigabit Ethernet LAN PHY, OC256, and OC768, LocalTalk, ARCNET, Token Ring, Ethernet (10 base-X), Fast Ethernet (100 base-X), FDDI, and Gigabit Ethernet (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, Ethernet (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, backplane protocols including, but not limited to, VMEbus, PC 104A, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor busses including, but not limited to, Fast Simplex Link (FSL), On-chip Peripheral Bus (OPB), Local Memory Bus (LMB), and Xilinx PowerPC microprocessor busses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Controller Unit 111 is the data interface between PD 105 and LED Lamps 107; and optional Sensors 108, Com Channels 109, and Other Devices 110. Controller Unit 111 is a digital computer used for automation of electromechanical processes, such as, but not limited to, control of machinery, LED light fixtures, etc. Controller Unit 111 is shown configured with Controller 113 for receiving operating instructions from Control App 101A and/or Control App 101B and/or Smart Grid App 103 for controlling LED Lamps 107, and optional Sensors 108, Com Channels 109, and Other Devices 110. LED Lamps 107 are solid-state, and use light-emitting diodes (LEDs) as the source of light. The LEDs involved may be devices such as, but not limited to, conventional semiconductor light-emitting diodes, organic LEDs (OLED), or polymer light-emitting diodes (PLED) devices, although PLED technologies are not generally commercially available. In addition, LED Lamps 107 includes an integrated PSE 104B for the distribution of power, and the transmission/receipt of data.

Optional Sensors 108 are devices that measure a physical quantity and convert it into a signal which can be read by an observer or by an instrument. Instead of being directly connected to Controller Unit 111 as shown in FIG. 1, optional Sensors 108 are connected to LED Lamps 107 for data transmission/receipt and power sourcing. For example, a thermocouple converts temperature to an output voltage which can be read by a voltmeter. Examples of optional Sensors 108 that may be included, include, but are not limited to, microphones, carbon dioxide sensors, carbon monoxide detectors, chemical field-effect transistors, electrochemical gas sensors, holographic sensors, infrared sensors, nondispersive infrared sensors, microwave chemistry sensors, nitrogen oxide sensor, olfactometers, optodes, oxygen sensors, pellistors, potentiometric sensors, redox electrodes, smoke detectors, zinc oxide nanorod sensors, electric current meters, electric potential, magnetic sensors, ammeters, current sensors, galvanometers, hall effect sensors, magnetic anomaly detector, magnetometers, MEMS magnetic field sensors, metal detectors, multimeters, ohmmeters, radio direction finders, voltmeters, voltage detectors, watt-hour meters, humidity sensors, air flow meters, Geiger counters, neutron detectors, photoelectric sensors, motion detectors, charge-coupled devices, calorimeters, electro-optical sensors, flame detectors, kinetic inductance detectors, LEDs as light sensors, light-addressable potentiometric sensors, Nichols radiometers, fiber optic sensors, photodetectors, photodiodes, phototransistors, photoelectric sensors, photoionization detector, photomultipliers, photoresistors, photoswitches, phototubes, scintillometers, visible light photon counters, barometers, pressure sensors, load cells, magnetic level gauges, strain gauges, bolometers, bi-metallic strips, infrared thermometers, microbolometers, microwave radiometers, net radiometers, quartz thermometers, resistance temperature detectors, resistance thermometers, silicon bandgap temperature sensors, thermistors, thermocouples, thermometers, alarm sensors, occupancy sensors, proximity sensors, passive infrared sensors, reed switches, triangulation sensors, bio-sensors, radar, ground penetrating radar, synthetic aperture radar. These sensors may use technology such as, but not limited to, active pixel sensors, back-illuminated sensors, catadioptric sensors, carbon paste electrodes, displacement receivers, electromechanical film, electro-optical sensors, Fabry-Pérot interferometers, image sensors, inductive sensors, machine vision technology. microelectromechanical systems, micro-sensor arrays, photoelasticity, sensor fusion, sensor grids, sensor nodes, sonar, transducers, ultrasonic sensors, video sensors, visual sensor networks, Wheatstone bridges, wireless sensor networks, frame grabbers, intensity sensors, chemoreceptors, compressive sensing, hyperspectral sensors, millimeter wave scanners, magnetic resonance imaging, diffusion tensor imaging, functional magnetic resonance imaging, molecular sensors, etc.

Optional Com Channels 109 (Communication Channels) in telecommunications and computer networking, refers either to a physical transmission medium such as a wire, or to a logical connection over a multiplexed medium such as a radio channel. Instead of being directly connected to Controller Unit 111 as shown in FIG. 1, optional communication Channels 109 are connected to LED Lamps 107 for data transmission/receipt and power sourcing. A channel is used to convey an information signal, for example a digital bit stream, from one or several transmitters, to at least one receiver. A channel has a certain capacity for transmitting information, often measured by its bandwidth in Hz or its data rate in bits per second. The channels can be analog, digital, multiplexed, shared, point-to-point, simplex, duplex, half-duplex, broadcast, unicast, multi-cast, etc. Information is carried through the channel via a signal. The signal can be transmitted/received using a wide variety of protocols, such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2x, PCI 64/66, Ultra-640 SCSI, AGP 4x, PCI-X 133, InfiniBand, PCI Express (x4 link), AGP 8x, PCI-X DDR, HyperTransport (800 MHz, 16-pair), PCI Express (x16 link), iSCSI (Internet SCSI), and Hyper-Transport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit Ethernet WAN PHY, 10 Gigabit Ethernet LAN PHY, OC256, and OC768, LocalTalk, ARCNET, Token Ring, Ethernet (10 base-X), Fast Ethernet (100 base-X), FDDI, and Gigabit Ethernet (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, Ethernet (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, backplane protocols including, but not limited to, VMEbus, PC 104, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor busses including, but not limited to, Fast Simplex Link (FSL), On-chip Peripheral Bus (OPB), Local Memory Bus (LMB), and Xilinx PowerPC microprocessor busses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Interfaces for the optional Communication Channel 109 to transmit/receive data via standard audio, video, and computer equipment jack and ports include, but are not limited to: connectors for twisted pair cable include the modular RJ type of jacks and plugs (RJ-11; RJ-14; RJ-22; RJ-25; RJ-31; RJ-45; RJ-48; RJ-61) (of four, six, and eight position configurations) along with the hermaphroditic connector employed by IBM. The hermaphroditic connector is specific to STP and is also known as STP connector, IBM data connector, or universal data connector. The connector used with patch panels, punch-down blocks, and wall plates, is called an IDC (insulated displacement connector). Modular Y-adapters used for splitting usually in 10 Base-T, Token Ring, and voice applications. Also, crossover cables which are wired to a T586A pinout scheme on one end and a T586B pinout on the other end. Coax connectors used with video equipment are referred to as F-series connectors (primarily used in residential installations for RG-58, RG-59, and RG-6 coaxial cables). Coax cables used with data and video backbone applications use N-connectors (used with RG-8, RJ-11U, and thicknet cables). When coaxial cable distributes data in commercial environments, the BNC (Bayonet Niell-Concelman) connector is often used. It is used with RG-6, RG-58A/U thinnet, RG-59, and RG-62 coax cable. Fiber-optic connectors include SC, duplex SC, ST, duplex ST, FDDI, and FC. These relate to different types of fiber-optic cables and configurations. Three of the SFF connectors that have recently been propagated (for fiber-optic cables are LC, VF-45, and the MT-RJ, etc. Instead of being directly connected to Controller Unit 111 as shown in FIG. 1, optional Other Devices 110 are connected to LED Lamps 107 for data transmission/receipt and power sourcing.

Other Devices 110 can include technology such as, but not limited to, Radio Frequency Identification (RFID) readers, barcode readers, cameras, wired and wireless switches, wired and wireless routers, wired and wireless hubs, alarms, femto-cells, pico-cells, micro-cells, smart card readers, etc.

Various devices in which the present invention can be implemented as Tx/Rx combination power and/or data delivery devices, include, but is not limited to, modems, PC boards, cell phones, set-top boxes, televisions, GPS receivers, ATM machines, landline phones, VoIP wireless phones, VoIP landline phones, DLC equipment, digital cameras, electrical outlets, interface devices that plug into electrical outlets, iPODs, Rios, etc., DVD players/recorders, on card/board communications, on back-plane communications, RFID readers, computer mouse, PDAs, computers, laptops, notebooks, eternal hard drives, CD burners, DVD burners, gaming equipment—X Box, Nintendo, etc., camcorders, copiers, fax machines, printers, cash registers, bar code readers, LCD projectors, PBXs, home networking devices, entertainment centers, PVRs, wireless/wire line switch (couplers), sensors, clocks, audio speakers, servers, power line jumpers (breaker box), DSLAMs, ISLAMs, amplifiers, monitors, video displays, RFID tags (non-UWB), RFID tags (UWB), smart cards, Cable TV head-end and field equipment, Cable TV CPE equipment, Broadband Power Line (BPL) head-end and field Equipment, BPL CPE equipment, in-building powerline communication system controllers, databus controllers, etc.

The present invention has been described in particular detail with respect to several possible embodiments. Those of skill in the art will appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different platforms. Furthermore, the computers referred to in the specification may include a single processor or may be architectures employing multiple processor designs for increased computing capability.

The scope of this invention should be determined by the appended claims and their legal equivalents, rather than by the examples given.

What is claimed:

1. A method for turning LED lights on or off using modified power-over-ethernet equipment, the method comprising:
toggling an electro-mechanical switch on a wall mounted light switch;
sending a wireless signal from the wall mounted switch to a control app;
sending a signal from the control app to a modified power-over-ethernet switch; and
turning a specific power-over-ethernet port either on or off in accordance with the control app signal received in the modified power-over-ethernet switch, wherein the signal is indicative of the position of the mechanical switch on the wall mounted light switch.

2. A method for dimming LED lights on or off using modified power-over-ethernet equipment, the method comprising:
manually adjusting an electro-mechanical switch on a wall mounted light switch;
sending a wireless signal from the wall mounted light switch to a control app;
sending a signal from the control app to a modified power-over-ethernet switch; and
the modified power-over-ethernet switch dimming a specific power-over-ethernet port in accordance with the control app signal, wherein the signal is in accordance with the position of the mechanical switch on the wall mounted light switch.

3. A method for turning LED lights on or off using modified power-over-ethernet equipment, the method comprising:
measuring a level of light in proximity to an LED light;
sending a signal to a control app;
sending a signal from the control app to a modified power-over-ethernet switch; and
the modified power-over-ethernet switch turning a specific power-over-ethernet port either on or off in accordance with the control app signal, wherein the signal is in accordance with the position of the mechanical switch on the wall mounted light switch.
